(19) United States
(12) Patent Application Publication
(10) Pub. No.: US 2008/0094251 A1
(43) Pub. Date: Apr. 24, 2008

(54) Control System

(76) Inventor: Rudolf Benecke, Bayreuth (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/569,621

(22) PCT Filed: May 25, 2005
(86) PCT No.: PCT/EP05/05666

§ 371 Date: Sep. 17, 2007

(30) Foreign Application Priority Data
May 27, 2004 (DE) 20 2004 008 446.5
Aug. 23, 2004 (DE) 20 2004 013 161.7

(51) Int. Cl. G07B 15/00; G07F 17/24

(52) U.S. Cl. 340/932.2

(57) ABSTRACT

The present invention relates to a control system, in particular for driving in or driving out of a parking garage, with a blocking and/or display device (1), which blocks or allows the passage of a motor vehicle, an input device (20) which is operable to allow the passage, wherein the input device (20) optionally comprises the receipt of an operation confirmation, and an output device (30) independent from the input device, which provides at least one information carrier (40), wherein the blocking and/or display device (1) only allows the passage when the information carrier (40) is removed from the output device (30) (FIG. 2).

### 1. TECHNICAL FIELD

The present invention relates to a control system for controlling the passage of motor vehicles and a device for outputting an information carrier to a user of the control system.

### 2. PRIOR ART

Systems for controlling the access passage of motor vehicles are employed in the most various situations. Examples for such systems are border control and toll roads as are parking garages and parking lots in city centers or shopping centers.

Control systems for passage control according to the prior art (see FIG. 1) exhibit in general a barrier 100 or at least a signaling device like a traffic light, with which the opening or the blocking of the passage is indicated to the driver of the motor vehicle. The opening occurs either automatically or in response to an input of the driver of the motor vehicle into the control system. In a parking garage the due amount is first paid at the pay machine or at the cash desk in prior art systems. The driver of the motor vehicle gets a card or similar, which he introduces in an input device 200 of the control system when driving out of the parking garage, whereupon the passage is enabled by lifting a barrier and/or illuminating of an appropriate signal. In some embodiments the control system releases the card or issues a receipt and the barrier 100 is first opened after the removal or this operation confirmation.

Similar systems are used when the passage of the individual people must be controlled, for example at a ski lift or at the entrance to an underground.

In some situations it is however, in addition to the verification and confirmation that the due amount was paid, desirable to ensure that the driver of the motor vehicle or the person has received specific information. For instance in the area of borders one can find large display panels, with which the special traffic regulations in the country across the border are brought to one's attention. In a similar way the user of a parking garage is confronted at the entry into or exit from the garage with a multitude of signs, which indicate the rules for use or similar. It is often attempted to win the attention of the driver of the motor vehicle by means of various advertisement boards while waiting to be allowed to pass. Similar considerations hold also for people who pass through passage control, for instance skiers at the lift.

It has been however established, that the probability of conscious perceptions of such additional information by a driver, a pedestrian or a skier etc. at a control system is relatively low. At the latest after passing through barrier is the attention of the driver of the motor vehicle or of the individual again drawn to the traffic respectively to the other environment and the danger is high that the content of the only shortly looked at information panels is forgotten.

According to a first aspect it is therefore the problem underlying the present invention to enhance the above described prior art control systems in such a way, that important additional information is recognized with a higher probability.

According to a further aspect, it is therefore the problem underlying the present invention to supplement the already existing control systems in a cost-effective way, in order to ensure that a mentioned functionality is achieved, i.e. the specific information is recognized by a user of the system, for instance a driver of the motor vehicle or another person, while passing the control system.

### 3. SUMMARY OF THE INVENTION

The present invention solves this problem according to a first aspect by providing a control system, in particular for driving into or driving out of a parking garage, with a blocking and/or display device which blocks or allows the passage for a motor vehicle, an input device which is operable to allow the passage, whereupon the operation of the input device optionally comprises the receipt of an operation confirmation, and an output device independent from the input device which provides at least an information carrier, wherein the blocking and/or display device allows the passage only after the information carrier is removed from the output device.

According to the invention the additional information is not only presented in a passive way only, but also coupled in an active way with the allowing of the passage. First when the driver of the motor vehicle removes the provided information carrier, he reaches his desired goal of opening the passage. With this it is ensured with a 100% probability that the information carrier reaches the inside of the vehicle, where it is noticed by the driver, the front-seat passenger, or by other people. Special traffic regulations of a destination country or safety regulations on a toll road are communicated with the control system according to the invention just as reliable as advertisement messages.

In an embodiment of the present invention the blocking and/or display device allows the passage after a certain amount of time has lapsed since operating the input device, even without removing the information carrier. This provides a minimum of freedom of choice for the driver of the motor vehicle and allows him to abandon the offered information carrier—for example an advertising prospect.

The output device comprises preferably a storage device for a number of preferably identical information carriers. When the storage device contains no more information carriers the blocking and/or display device allows the passage preferably immediately after operating the input device. In this way the control system can automatically switch from the operation mode according to the invention into the normal operating mode known from the prior art, for the case that no information carriers are available anymore to dispense. Preferably, the control system further comprises a monitoring system, which in the case of the malfunction of the input device and/or of the output device instructs the blocking and/or display device to allow the passage.

In a particularly preferred embodiment, the input device identifies the driver of the motor vehicle and/or the motor vehicle. This enables that the blocking and/or display device allows the passage even without the removal of any information carrier, when the driver of the motor vehicle and/or the motor vehicle belongs to a predefined group. This further development of the invention is applicable for instance in parking garages, which are used also by tenants who do not need to be offered the information carrier anew when driving into or driving out of the parking garage.

According to a further aspect, the present invention relates to a device for dispensing an information carrier, especially an advertising medium, to a user of a control system, comprising a sensing unit with a sensor, to recognize an operation of the control system by the user without contact, and a dispensing unit, which is built to provide the information carrier for removal by a user at the recognition of an operation of the control system.

The device according to the invention can be arranged as an addition module in the immediate vicinity of an already existing control system, for instance a barrier at the entrance to a parking garage or shopping center or similar without any modifications. Each time a user operates the control system for instance when he withdraws a card on which the time when the user drives into the parking garage is stored, this corresponding operation is recorded by the sensor according to the invention. Since the sensor operates without contact, it does not necessarily require a link with the existing control system, i.e. in the above described example of the barrier control. The sensor can involve an infrared sensor, a photo sensor, a camera with corresponding image processing, or similar. Possible is also the combination of more sensors to reliably detect the operation of the control system by the user.

The dispensing unit of the device according to the invention keeps the information carrier ready for instance with safety hints for the user of the parking garage or an advertising voucher for the affiliated shopping center. The user will take this information carrier with him with a high probability, alone for the fact that in the short time available he can not identify whether this is required or not for allowing the passage or similar. As a result it is ensured that the content of the information carrier is recognized by the user.

Preferably the device does not comprise any electrical signal link to the control system. This embodiment can be installed and de-installed with minimal technical effort, for instance for temporarily limited advertising or information campaigns. An alternative embodiment comprises an interface for generating an electrical signal link to the control system. This enables the linkage of both systems, either with a purpose of influencing the function of the control system or only to ensure in addition to the contact-less sensor that an information carrier is dispensed at the right time.

The sensor is preferably arranged in such a way, that it detects the user and/or a motor vehicle, in which the user travels, when the control system is operated. This can be easily realized with the sensor technologies exemplarily mentioned above.

It is particularly preferred that the dispensing unit of the device comprises control means, which retract the information carrier at least partially if it not removed by the user. This way it can be ensured that the information carrier at the next operation by another user is provided again and thereby actually noticed. An actively provided information carrier will be with clearly higher probability received by a user than an only passively offered medium.

Preferably, the device comprises further a display unit, which points the user to the removal of the provided information carrier. This can be realized via appropriate optical indicators, displays, blinking lights with or without acoustical support. The content and the form of the display unit are preferably customizable realized.

Additional favorable developments of the control system and device according to the invention are defined in the further dependent claims.

### 4. SHORT DESCRIPTION OF THE FIGURES

In the following the individual technical aspects of the present invention are more precisely explained with reference to the accompanying figures. These figures show:

FIG. 1: a control system according to the prior art;

FIG. 2: a schematic representation of the basis elements or the control system according to the invention in a preferred embodiment;

FIG. 3: a detailed representation of the input and output devices of the control systems in a preferred embodiment of the invention;

FIG. 4: a schematic side view of a preferred embodiment of the device according to the invention next to a control system with a barrier;

FIG. 5: a detailed view from above of the arrangement of FIG. 4; and

FIG. 6: a detailed view of an alternative embodiment of the device according to the invention next to a control system.

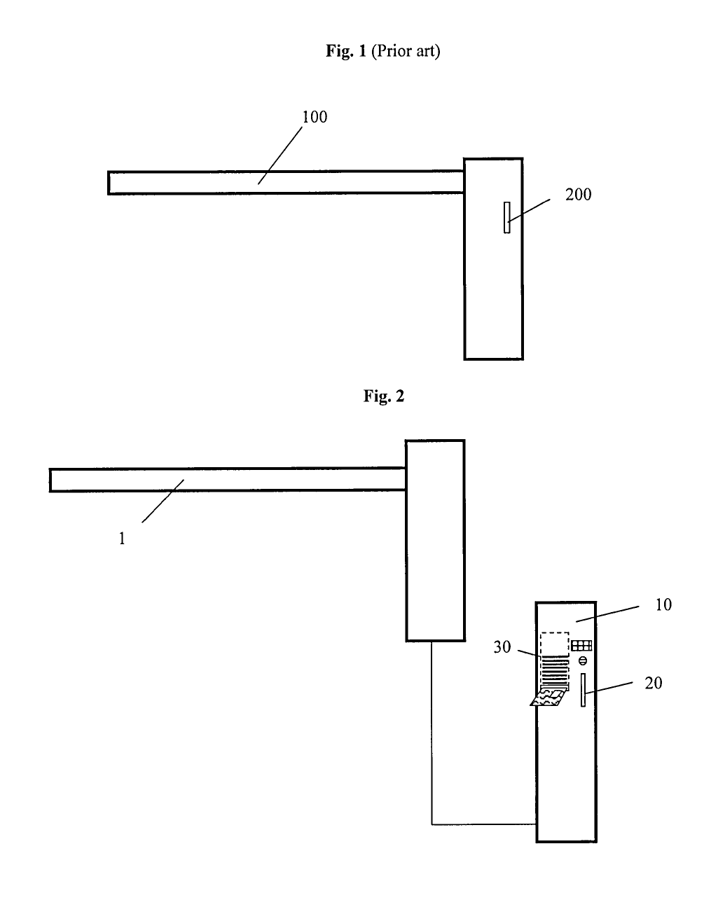

### 5. DETAILED DESCRIPTION OF PREFERRED EMBODIMENTS

In the following a first aspect of the present invention will be described in more detail by means of an example of a control system for driving out of a parking garage. It is however understood, that such a control system can be used in all situations in which in addition to controlling the passage the most various types of information should be communicated to the driver or a person passing the control system in another way.

For instance, the control system described could also be part of a customs clearance system at a border. In this case the information carrier provided by the output system could be a flyer with specific traffic regulations or similar in the destination country. Another possible application is the output of an information carrier at the entry of a toll road for recording of the kilometers traveled or similar. With a system according to the invention it can be ensured, that not only the data carrier is removed, but that the driver also notices additional information about the toll road/toll etc. on an additional information carrier.

FIG. 2 shows schematically the general configuration. The passage of the vehicles out of a parking garage is controlled with a barrier 1. Next or before the barrier 1 there is a control device 10. The control device 10 can be either directly integrated with a drive of the barrier 1 or can be provided as a separate module as shown in FIG. 2. The modular configuration facilitates especially the refitting of the existing control systems with the features of the present invention. Instead of the barrier 1 a blocking fence can also serve to block the passage. It is also conceivable instead of this or additionally to use a traffic light for passage control.

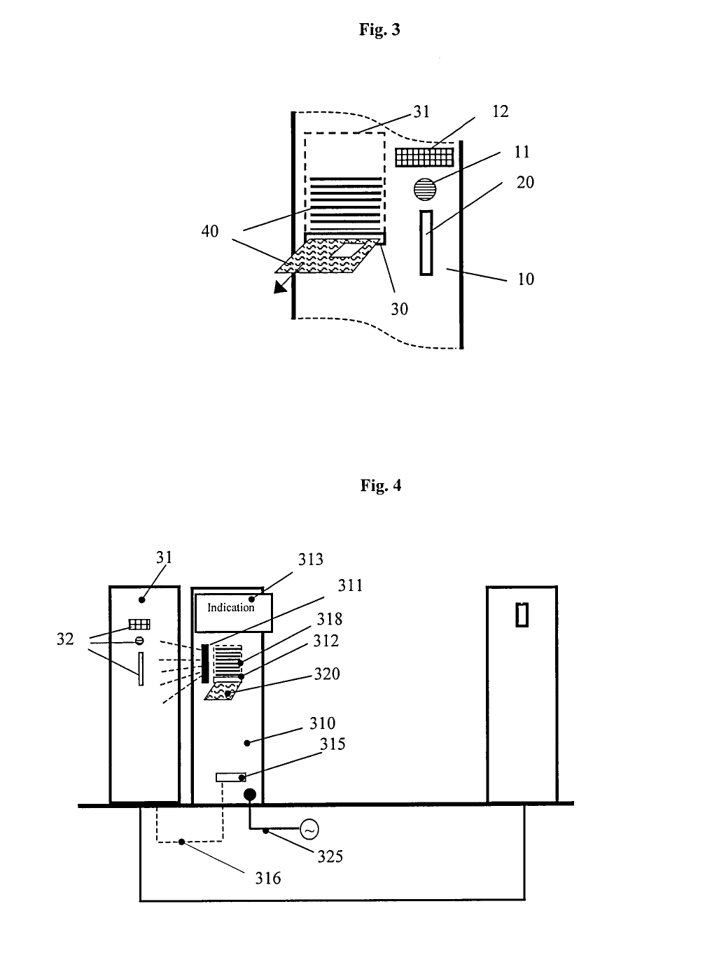

The control device 10 comprises two, from one another separate, systems (see FIG. 3). In an input device 20—for instance an appropriate slot—introduces a driver, who wants to open the barrier 1, first a card or similar which he obtained from the cash desk or from a cash machine of the parking garage (not shown). The card can be either drawn in by the input device 20, or it can be released as voucher for receipt back to a driver (not shown). Instead of inputting a card, a slot for coins or payment device for a cash card or similar can be provided, which if applicable additionally provides a receipt.

Independent from the input device 20 the control device 10 comprises an additional output device 30, which provides an information carrier 40 for removal by the driver. FIG. 3 shows this step. Through an opening slot of the output device 30 the information carrier 40 is pushed out in the direction of the motor vehicle staying in front of it (not shown). Since the opening slot is essentially located at the same height of the control device 10 as the input device 20, the driver can remove directly through a car's window the information carrier 40 provided. This removal is detected—mechanically, optically, or in another way—by an appropriate sensor. Thereby the barrier 1 is lifted, so that the passage is allowed.

FIG. 3 shows exemplarily how a plurality of information carriers 40 can be stored for output. The information carriers 40, for instance advertising brochures of a business or safety instructions from the operator of the parking garage, are pilled up in a storage container 31. By means of an appropriate mechanic it can be ensured in a known way, that exactly one information carrier 40 is provided for removal. By this individual presentation of an information carrier 40 and the lifting of the barrier 1 only after the removal of the information carrier by the driver, it is ensured with high probability that the information carrier 40 ends up in the inside of the motor vehicle, where it is noticed by the driver or by other people.

The storage container 31 is preferably refilled from above or from the side. Conceivable is also a connection with a larger container, which feeds automatically the storage container 31 with the information carriers 40 via a conveyor belt, in order to ensure a continuous operation of the control device 10. If however all the information carriers 40 have been removed, the control device 10 switches so that the barrier 1 is lifted immediately after the correct operation of the input device 20.

Preferably the driver is pointed to the provided information carrier. For this purpose the control device 10 can contain a loud speaker 11 and/or an optical display 12 as shown schematically in FIG. 3, with which the driver is informed that the barrier 1 only opens when the provided information carrier is removed.

For the employment in a parking garage, which is visited not only by continuously changing motor vehicles, but also by tenants of the garage, it is beneficial to identify the drivers or their motor vehicles. Then the barrier can be opened also without the removal of an information carrier 40, in order to avoid that a tenant of the garage is obliged to remove an information carrier 40 each time when leaving the parking garage.

In an advanced embodiment the control device 10 can differentiate not only among temporary clients and tenants, but it can also detect when it was the last time when a driver removed an information carrier 40. If for example, meanwhile the information on the information carrier 40 has changed, it can make sense to provide the modified information carrier 40 in the described way also to a tenant of the garage. In this way the administration of the parking garage can inform the clients about the modified usage instructions. Finally, it is conceivable to modify the control equipment in such a way, that depending on the individual identification of the motor vehicle or its driver different information carriers are provided.

So that the driver of the motor vehicle is not completely obliged to remove the information carrier, the control device 10 comprises an interval timer (not shown), so that the barrier 1 allows the passage once the predefined time has lapsed even without the removal of the information carrier. It makes sense to have also an additional monitoring system (not shown), which permanently monitors the entire system including the input device and/or the output device and which in case of a malfunction instructs the blocking and/or the display device to allow the passage also without the removal of an information carrier. This way a paper jam in the storage container 31 does lead to a total failure of the entire control system.

Besides provisioning of the information carriers made of paper such as flyers, brochures, or similar, the output of data storage carriers is also conceivable. For example, an advertising department store with own underground parking could provide for removal in this way free CDs or other data storage carriers, with which products or services of the department store are being advertised. It is especially beneficial when the output device 30 and the storage container 31 are constructed in a way that the information carriers of different sizes and types can be provided. This way, the advertising carrier can be flexibly varied for the mentioned usage of the described control system for advertising purposes.

The FIGS. 4-6 show a further embodiment of the present invention, which can be used preferably as a device for supplementing an already existing control system. Conceivable is for instance an arrangement next to an already existing barrier control system of a parking garage or similar, with which the passage of a motor vehicle is controlled. It is understood however, that the present equipment for outputting of an information carrier can also be used together with other control systems, for instance a system for access control of individual people to a cable car or a ski lift.

The technical details of the barrier control are explained in the following description only as far as they are relevant for the output device according to the further embodiment. Instead of a barrier, as shown in FIG. 4, simple traffic light control or other light signals can also be used as well as all types of mechanical blocking devices for persons, vehicles, etc.

Next to a barrier control 31 there is a device 310, which in the preferred embodiment as shown in FIG. 4 comprises a pillar 310 for incorporating the components of the device. Conceivable are also other configurations for accommodating different deployment situations. Inside the pillar 310 there are arranged one or more sensors 311, which monitor the area of one or more input devices 32 of the barrier control 31. In the embodiment shown in FIG. 4, the sensor 311 is arranged in the upper region of the pillar 310. Other positions are also conceivable, also outside of the pillar 310. In this case, the signals received from the sensor 311 are transmitted over a cable or wireless link to a central control of the device, which is preferably arranged inside the pillar 310 (not shown).

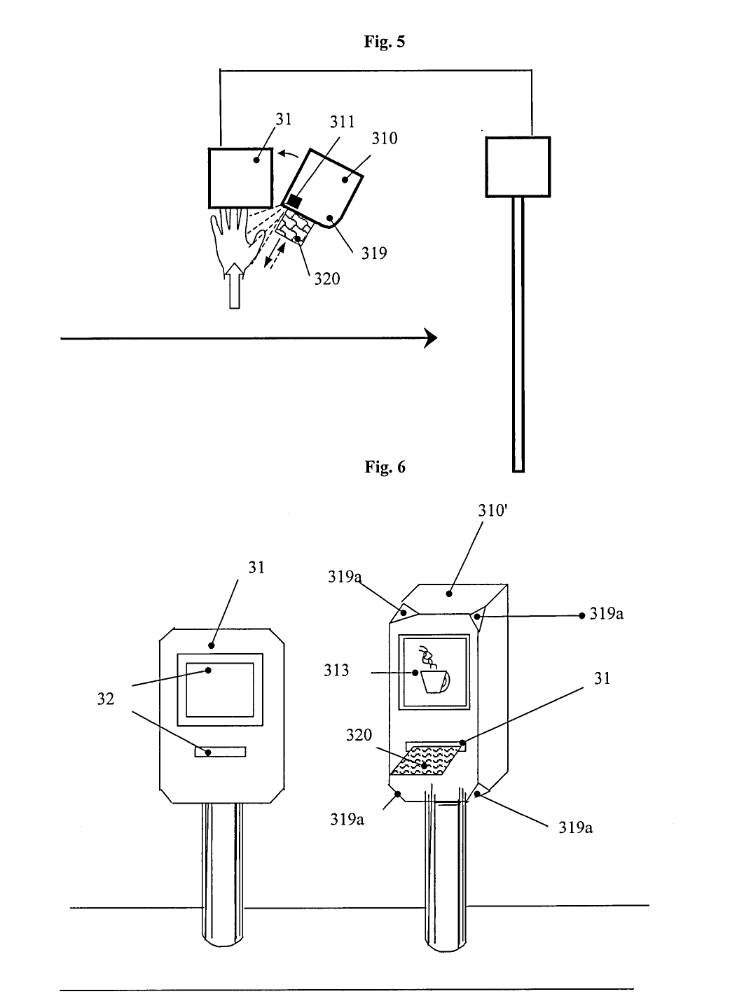

As contact-less sensors in the sense of the existing invention can be considered all devices which can detect that the user operates the control system, without being necessary that the user himself actively interacts in some way with the device 310. For example an infra-red sensor, a radar sensor, a light barrier or a camera could be placed essentially at the height of the input device 32. It is also conceivable to use a contact rod, which triggers under the weight of the user or his motor vehicle. As schematically shown in FIGS. 4 and 5 by the dashed lines, the sensor 311 detects for example the hand of user when he operates the input device 32 of the barrier control 31, for instance when he removes a card on which the entry time in the parking garage is recorded and which is later used for charging the parking fees. Alternatively, or additionally, it is also conceivable to detect the motor vehicle of the user, when it stops in front of the control system. The one or more sensors 311 are in their position and orientation preferably customisable realised, so that they could match the specifics of the corresponding control system.

If the user is detected by the sensor 311, then the output device 312 provides an information carrier 320 (see continuous arrow in FIG. 5). Since the pillar 310 is placed in the immediate vicinity of the input devices 32 of the barrier control 31, the information carrier 320 is preferably provided in such a way, that the user can immediately reach it (see FIG. 5). Preferably the provision of the information carrier 320 occurs slightly time-delayed, i.e. after the user has operated the input device 32, so that he is not surprised by the provided information carrier 320.

A display 313, for example an LCD display, preferably integrated in the pillar 310 can provide additional information for the operation of the input device 32 or for the information carrier 320. For example, on the display 313 it can be pointed to a special advertising action, which is content related to the information carrier 320. A content of the display 313 is customisable and can therefore be flexibly adapted to the content of the corresponding information carrier 320 but also to the specifics of the barrier control 31 arranged in the vicinity. This can be realized via corresponding storage media inside the pillar or, when a (wireless) network link is available, via an online connection from a remote computer. In addition the display 313 or a similar device can also give acoustical signals and the attention of the user can be increased through additional means, such as blinking lights, running text, etc. The design of the display 313 is preferably modifiable, so that not only the content of the display 313 but also its outer shape can be easily changed.

As information carrier 320 the most different media can be basically considered. Besides paper brochures or vouchers, data storage media such as free CDs, or similar, or the output of small samples of a product are conceivable. Inside of the pillar 310 there exists preferably a storage device 318 for receiving a plurality of information carriers 20, such that the device 310 is operational over a longer period. It is also conceivable to store two or more different types of information carriers 320 (not shown) and make their release dependent on further parameters. It is for instance conceivable depending on the time of day to output different advertising carriers and/or to provide the advertising carriers with current data, for instance with a printed identification number, whereas the information on the display 313 is correspondingly adapted. The control of the choice among different information carriers 320 and/or imprint can also be done on line from a remote computer or under the control of a data processing device (not shown) associated with a device 310. Also a combination of both variants is possible.

In the case that the user does not remove the provided information carrier 320 within a predefined amount of time, a time control (not shown) in the device 310 ensures that the information carrier 320 is retracted (see dashed arrow in FIG. 5). In this way the damage of the information carrier 320 is prevented and simultaneously it is ensured that each time when the sensor 311 detects a user an information carrier is actually actively provided and held ready. This increases the attention of the user to the offered information carrier, which will be noticed by the user with clearly higher probability than a motionless offered information carrier. Beside the time control it is also conceivable to retract the information carrier 320 as soon as the sensor 311 detects that the hand of the user or similar is not in front of the input device 32 anymore. This option can be additionally combined with a time control.

Moreover, it can be ensured via additional acquisition sensors, that the user really belongs to a desired target group (not shown). This way it can be verified with an appropriately arranged induction loop, whether the user is inside a motor vehicle when the sensor 311 detects a user, in order to ensure that the information carrier 320 is released only to a passenger of a motor vehicle and not to a pedestrian. With this addition it can also be ensured by using an appropriate logic circuit that only one information carrier is provided per motor vehicle. This is for example important when the information carrier is a voucher, which is offered when driving into the parking garage of a department store.

Similar modifications are conceivable also for control systems and corresponding devices for pedestrians (not shown). In the simplest case the already mentioned time control ensures not only that a not taken information carrier 320 is retracted, but it also monitors that per time unit not more than a pre-defined number of information carriers is output.

The view from above in FIG. 5 shows that a device 310 is arranged preferably slightly angled towards the input device 32 of the barrier control 31. This facilitates the output of the information carriers 320 in an area in front of the input device 32 of the barrier control 31, where the user can easily reach it.

Preferably the most extending edge 319 of the pillar 310 is rounded and/or additionally manufactured from rubber or similar material, in order to avoid the damaging of a motor vehicle driving in (see horizontal arrow in the view from above in FIG. 5). In addition, the complete device 310 can be pivot mounted to an edge, so that it gives way via a rotation at the contact with the motor vehicle, as shown in FIG. 4 through a bent arrow. Moreover, the pillar 310 is preferably very robustly built, in order to prevent damage by vandalism.

FIG. 6 shows a detailed view of an alternative embodiment of the present invention, in which the device 310′ is realised as a box mounted on a pillar. The device 310′ is preferably rounded or slanted on all front corners 319a facing the user, in order to minimize the risk of injuries or damage to a motor vehicle (not shown) driving by.

FIG. 6 shows further the display 313 integrated in the device 310′ having a preview or similar of the information output through the output device 312 on the information carrier 320. This information preview is preferably of a graphically illustrated type and increases for this reason the interest of the user in the information carrier 320.

If the barrier control 31 allows for a simple electronic coupling, it is beneficial that the device 310 also comprises an interface 315 with which a signal link 316 between the two devices can be established (see dashed line in FIG. 4). A signal link 316 is not absolutely necessary because of the usage of the sensor 311. It makes however possible the implementation of additional functions. For example a counter in the control unit (not shown) of the device 310 could store the percentage of openings of the barrier control 31 for which an information carrier 320 was taken by the user. In this way, conclusions can be drawn concerning the degree of awareness of the user about the safety regulations or it can also be investigated the response behaviour of the user to an advertising campaign and corresponding advertising media.

In a simple embodiment there exists however no link, especially no signal link 316 between the barrier control 31 on one side and the device 310 on the other side. In this case the device 310 can be within the shortest time deployed next to a barrier control, for instance for a time limited advertising campaign in which vouchers are given away at the entrance into a parking garage of a shopping center. Then, the device 310 must be solely connected to the power supply system (not shown) via a cable 325. The required power supply could also be provided via an appropriate connection to the power supply of the barrier control 31. For a time limited deployment it is also conceivable to supply power to the device 310 via an internal or external accumulator (not shown). Such a device can be employed extremely flexible and can be moved within a few minutes from the entrance to the exit of the parking garage. Alternatively or in addition to, an independent power supply can be realised by solar power, whereas the corresponding solar cell or cells are mounted preferably on the top and/or the sides of the device 310.

1. Device (310, 310′) for outputting an information carrier (320), especially an advertising medium, to a user of a control system (31), with
a. a sensing unit with at least one sensor (311), for sensing contact-less the operation of the control system (31) by the user; and
b. an output unit (312), which is designed to provide the information carrier (320) for removal by the user, at the sensing of the operation of the control system (31), characterized in that
c. the output unit (312) further comprises control means, which controls that per time unit not more than a predefined number of information carriers is released.

2. Device (310, 310′) according to claim 1, wherein the device does not comprise an electrical signal link to the control system (31).

3. Device (310, 310′) according to claim 2, wherein the device comprises an interface (315) for the creation of an electrical signal link (316) to the control system (31).

4. Device (310, 310′) according to claim 1, wherein the sensor (311) is arranged in such a way, that it senses the user and/or the motor vehicle in which the user sits at the operation of the control system (1).

5. Device (310, 310′) according to claim 1, wherein the sensing unit is arranged exchangeable at the output device.

6. Device (310, 310′) according to claim 1, wherein the output unit (312) is customizable for information carriers (320) of different sizes.

7. Device (310, 310′) according to claim 1, further comprising a storage device (318) for a plurality of identical information carriers (320).

8. Device (310, 310′) according to claim 1, further comprising a display unit (313) for pointing the user to the removal of the provided information carrier (320).

9. Device (310, 310′) according to claim 8, wherein the design of the display unit (313) is realized customizable.

10. Device (310, 310′) according to claim 1, wherein the output unit (312) further comprises control means, which retract the information carrier (320) at least partially if the user does not remove it.
